(19) United States
(12) Patent Application Publication
(10) Pub. No.: US 2008/0306813 A1
(43) Pub. Date: Dec. 11, 2008

(54) METHOD FOR RECYCLING CONSUMER GOODS

(75) Inventor: Nicholas M. Romansky, Malvern, PA (US)

Correspondence Address: Connolly Bove Lodge & Hutz LLP;1007 North Orange Street, P.O. Box 2207, Wilmington, DE, 19899, US

(73) Assignee: Cloudview LLC, Minden, NV (US)

(21) Appl. No.: 11/538,988

(22) Filed: Oct. 5, 2006

Related U.S. Application Data
(63) Continuation-in-part of application No. 11/533,877, filed on Sep. 21, 2006, now abandoned.
(60) Provisional application No. 60/719,302, filed on Sep. 21, 2005.

(51) Int. Cl. G06Q 30/00

(52) U.S. Cl. 705/14

(57) ABSTRACT

A method to encourage consumers to return reusable or recyclable containers to the origin of purchase provides to the consumer a coupon or other proof of return to be redeemed for a discount on items made with or incorporating the recycled products returned by other consumers. The returned container may then be used by the seller or the seller's affiliate or agent as material to create more recycled consumer goods.

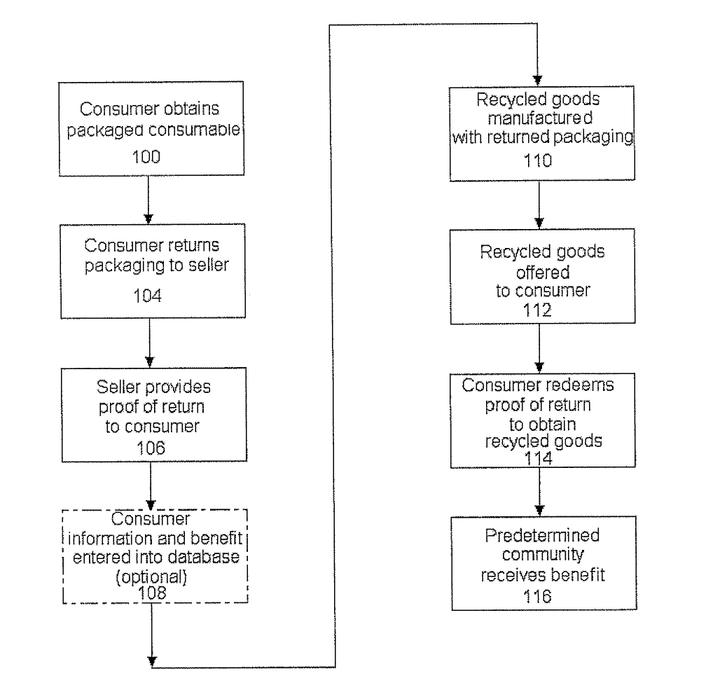

### CROSS-REFERENCE TO RELATED APPLICATIONS

This application claims priority from U.S. Provisional Application Ser. No. 60/719,302, filed Sep. 21, 2005, and U.S. patent application Ser. No. 11/533,877, filed Sep. 21, 2006.

### BACKGROUND OF THE INVENTION

Consumer goods are often contained in single-use disposable packaging. This type of packaging is convenient for the consumer, who merely throws the unwanted packaging away after consuming the enclosed goods. However, constant disposal of packaging is detrimental to the environment. For example, non-biodegradable packaging increases the number and size of landfills.

Halting the use of single-use disposable packaging materials which would be destined to end up in landfills promotes a cleaner environment. Reusing or recycling the packaging further promotes sustainability and environmental preservation. Sustainability is important for the long-term maintenance of ecosystem components for future generations.

Many companies demonstrate corporate social responsibility through a commitment to promote environmental and community fostering programs. A commitment to the communities of a company's retail locations, its partners, and its employees is often a guiding principle of their mission statement and promotes many community building programs.

Currently, consumers of packaged products have very few options regarding what to do with the packaging after it is no longer required. One option is for the consumer to discard the used packaging in any garbage container. This may be convenient for the consumer, but it disconnects the retailer and consumer after the initial purchase because the consumer has no direct incentive to return to the retailer to deposit the used packaging. The consumer may even patronize another retailer for future purchases if there is no incentive to return to the original retailer. Thus, there is a need to provide an adequate incentive for consumers to return to a given retailer for making future purchases.

Another disposal option for the consumer is to personally recycle the product. For example, many communities have their own recycling programs. Some retailers may provide for recycling, but if they fail to provide any incentive to recycle, any direct benefit to the retailer is curtailed. For example, the retailer may experience a limited number of consumers who participate in the recycling effort. Furthermore, the consumers may not be induced to make future purchases with the retailer if the primary purpose of a visit is merely to return recyclable goods, and there is no incentive to interact with salespeople or any advertising media within the store. Thus, there is a need in the industry to provide an incentive for the consumer to return packaging to a retailer in a manner that also favors additional purchases by the consumer from that retailer.

Many manufacturers and retailers would benefit from receiving returned packaging as a raw material for other products. Manufacturers would gain the benefit of obtaining returned goods capable of being reused in recycled products. Retailers would benefit from the fact that consumers who are returning the packaging are generally familiar with the retailer's goods and may be more inclined to purchase replacement goods when returning the used packaging from a previous purchase. This effect may be amplified by the goodwill generated if a benefit was conferred upon the consumer and/or the consumer's community for returning packaging that frequently is fairly useless to the consumer. Retailers could also enhance their public relations by utilizing the program to promote community and economic welfare. This encouragement may take the form of promoting current and potential consumers to recycle. Alternatively or additionally, some direct benefit may be conferred upon the community attributable to the purchase of selected merchandise.

Several systems are known for providing a benefit to a consumer who returns recyclable goods. For example, U.S. Pat. No. 4,285,426 to Cahill teaches a redemption apparatus and process for accepting the return of selected types of non-refillable refillable containers and issuing to the consumer either a monetary deposit refund or a coupon redeemable at a retail store for an amount in money or merchandise credit printed thereon. U.S. Pat. No. 5,257,741 to Rode, et al. discloses a method and apparatus for receiving returnable containers; dispensing a coupon, receipt or token to the consumer depositing the returnable container; and compiling and storing data regarding returned containers for subsequent retrieval.

However, according to these methods, the returned containers are shredded, destroyed or densified. Further, the benefit to the retailer is limited because the original advertising associated with the original packaging is lost in the shredding or destruction process. The benefit to the consumer is limited to a small monetary refund or coupon for future purchase, which may be insufficient to induce consumers to recycle. The community benefits from the reduction of waste in its landfills, but otherwise the community receives no benefit from its citizens' recycling efforts.

There, therefore, exists a need and desire in the industry to reuse or retain packaging in essentially its original form in order to preserve and promote brand recognition associated with the original packaging by incorporating the package labeling recycled consumer goods. Further, there exists a need for a more extensive recycling program that promotes sustainability by relating a benefit received by the recycling consumer and the community to the creation and sale of recycled goods created with the returned packaging.

Environmentally and socially conscious consumers also are often concerned about the plight of the environment and working conditions in the communities where the consumer products are grown, manufactured, packaged, and/or sold, and seek products that foster healthier environmental, economic, and social systems that are not reliant on the exploitation of workers or resources in those communities. These consumers are therefore drawn to companies that support the economy and environment of these communities. Thus, there is a need in the industry to attract and retain consumers by ensuring that the consumer's purchasing behavior and recycling efforts enhance the communities where any portion of the products are sold, produced or packaged.

Current methods of recycling, such as redeeming a deposit for returning bottles, do not generally benefit communities. Additionally, such programs only promote the immediate reuse of the packaging for its original purpose and do not promote the creation of new consumer products with the returned packaging. Recycling programs that do create new products with the recycled goods, as for example, in the paper industry, generally completely destroy the identity and design of the original returned goods, and consequently, any associated advertising aspects.

In view of the above and other objects, the following disclosure describes a novel method that encourages consumers to recycle by providing a benefit to the consumer, the retailer, and/or a predetermined community.

### BRIEF SUMMARY OF THE INVENTION

One embodiment of the present invention provides a method for encouraging consumers to return reusable or recyclable packaging to the origin of purchase. The consumer first purchases from a seller a consumable packaged with or within packaging. After the packaging is no longer required, the packaging is returned to the seller. The returned packaging is added to a supply of returned packaging received from other sources, such as other consumers. The seller or the seller's agent or affiliate creates recycled products using this cache of returned packaging. In exchange for returning the packaging, the consumer receives a credit, coupon, ticket, token or other proof of return to be redeemed for a discount on the purchase of recycled products made using returned packaging. The recycled products may then be sold through a catalog or other advertising means, such as the Internet. The consumer's credit or discount may also be stored in a computer database. The recycled products may be categorized based on a predetermined community, which includes the country of origin of 1) the original consumable, 2) the original packaging, or 3) the location of the original retail sale, or any other predetermined community selected by the retailer. The predetermined community may receive some monetary benefit merely for the return of packaging. Alternatively or additionally, a portion of the proceeds from the sale of the recycled consumer goods may be sent to the community to further promote environmental, economic, social, or community service programs. The method may substantially reduce the solid waste problem caused by the disposal of the packaging, which may be particularly advantageous in instances where the packaging is non-biodegradable. The method will also benefit communities and foster the retailer's goodwill. The method may also foster brand loyalty, increase sales of the seller's packaged goods and of recycled goods made incorporating the seller's packaging, promote sustainability of consumer products, and enhance the economics and/or environment of the communities.

### BRIEF DESCRIPTION OF THE FIGURE

Novel features and advantages of the present invention in addition to those noted above will become apparent to persons of ordinary skill in the art from a reading of the following detailed description in conjunction with the accompanying drawings wherein similar reference characters refer to similar parts and in which:

The FIGURE illustrates a flowchart of one embodiment of a method of the present invention.

### DETAILED DESCRIPTION OF THE INVENTION

As shown in the FIGURE, a consumer first purchases a consumable item that is contained within or attached to packaging, as shown in block 100. The consumable may comprise any item sold for consumption, such as food, beverage or other item. The packaging may comprise, metal, glass, plastic, wood, natural fibers, or other suitable material for the packaging of consumable goods. The packaging may or may not be biodegradable.

After the consumer purchases or receives the packaged consumable item, the consumer may consume the item as described in block 102. The consumption may involve, eating, drinking or making other use of the consumable. Alternatively or additionally, the consumable may be otherwise removed from the packaging for purposes such as serving or storage. Once the consumer removes the consumable from the packaging, and/or the consumer no longer requires the packaging, the consumer may return the packaging to the original seller as shown in block 104. Although block 104 indicates that the consumer returns the packaging to the seller, it is contemplated that the item could be returned to any retailer participating in the recycling program that will be described in further detail below. For example, in the case of a franchise or seller with multiple locations or affiliates, the item may be returned to any retailer.

As block 106 indicates, when the consumer returns to the seller or retailer with the packaging, the consumer receives a coupon, ticket, token, credit or other proof of return to be redeemed for a discount on items made with the recycled products returned by other consumers, as will be discussed in further detail, and by way of example, below. Additionally or alternatively, a benefit may be conferred upon a predetermined community in response to the packaging return. The predetermined community may be the country or community of origin of 1) the original consumable, 2) the original packaging, or 3) the location of the original retail sale. Alternatively, the seller or retailer may select any community of origin based on need.

At the time that the consumer exchanges the packaging for the proof of return, data may optionally be collected from the consumer, as shown in block 108. This data may related to the type of packaging returned, the consumer's purchasing behavior, the consumer's personal information, the frequency with which the consumer returns packaging, the amount of credit accumulated by the consumer for returning the packaging and/or other information related to the packaging return process or the seller's business generally. The database may be linked to a network for accessing the data at various locations.

The returned packaging may then be used by the seller or the seller's agent or affiliate as material for the creation of future recycled consumer goods, as block 110 indicates.

The recycled consumer goods may then be offered to consumers, as indicated in block 112. The products may be presented visually or descriptively to the consumer via a catalog, pamphlet, poster, or other advertising means, such as through the Internet. The items may be categorized based on a predetermined community which includes the country of origin of the original product, the packaging or the original retail sale, or according to any other classification selected by the retailer.

Alternatively or additionally, a consumer who has returned packaging on one or more occasions may redeem the proof of return to obtain the recycled products. A discount may be applied to a portion or to the entirety of the purchase price of the recycled products. The amount of discount available to the consumer may also be based on the frequency with which the consumer returned packaging and/or the quality or value of the packaging returned. Thus, the seller may assign different values to different types of packaging based on the supply and demand of the packaging design or the condition of the returned packaging.

As indicated in block 116, a portion of the proceeds for the sale of the recycled consumer goods may be sent to a predetermined community. The predetermined community may be the country or community of origin of 1) the original consumable, 2) the original packaging, or 3) the location of the original retail sale. Alternatively, the seller or retailer may select any community of origin based on need or other criteria selected by the seller or retailer. For example, the seller may select a community that has suffered a natural disaster or any other catastrophe. The proceeds may be disbursed to further promote that community's environment, economy, or general welfare. For example, the seller may develop partnerships or relationships with community service leaders and organizations.

The invention will now be more particularly described with reference to preferred embodiments. One such embodiment, which is not meant to limit the scope of the invention, will be described with respect to wine bottles or other beverage or food bottles or containers.

This preferred embodiment of the invention concerns reuse of wine or other beverage or food bottles or containers, and the labels displayed on such bottles or containers. A consumer may be encouraged to return wine bottles or other beverage bottles or containers to the seller or retailer or agent or affiliate. The consumer may be induced to return to the retailer in response to information obtained at the time of purchase, on the packaging, or by other advertising means that indicates the consumer will be entitled to a benefit if the bottle or container is returned to the store of purchase or any other participating retailer. As a supplement to the bottle deposit returned to the consumer under the laws of many states, the consumer may also receive a coupon or other proof of return to be redeemed for a discount on items made with recycled products. Alternatively or additionally, the consumer may be given a coupon toward the purchase of the next purchase of wine, beverage or other retailer merchandise. The retailer may additionally or alternatively maintain a database with consumer accounts for storing consumer information including the benefits attained by the consumer from wine bottle returns.

The location for returning the bottles or other containers may be on, in, or behind the counter upon which the cash register is located or anywhere that the consumable items are prepared, served or enjoyed. Alternatively, an independent return station may be provided within or outside of the retailer. Such an independent return station could be based on conventional receptacles as taught, for example, in U.S. Pat. Nos. 4,285,426 and 5,257,741. These return locations may be provided with advertising or instructions for informing consumers of the program and encouraging sales of food or beverages or other retail merchandise, particularly to encourage sales in order to obtain discounts on recycled merchandise in exchange for returning the bottles or other containers. Furthermore, other advertising may be located in these locations to promote any desired consumer behavior. For example, the retailer may advertise the latest wine, condiment or other beverage or food product to encourage the consumer to purchase further products.

The returned bottles or containers and/or labels from the same may then be used by the seller or the seller's agent as the raw materials for the creation of recycled consumer goods. Bags, wallets, purses, cell phone holders, or virtually any product can be made from these post-consumer materials. Preferably, the advertising aspects of the labels from the bottles are prominently displayed in conspicuous locations. A market may develop for goods made from the variety of recycled containers or labels, each with a particular or unique design or printed in a particular language. Thus, the original packaging may be utilized to create unique recycled products sought by consumers, regardless of their consumptive behavior with the original product, i.e., wine, beverage, food product or condiment. Incorporating the advertising aspects of the original packaging may also foster brand recognition and brand loyalty, thereby further benefiting the retailer.

The recycled consumer goods may be sold via a catalog or other advertising means, such as the Internet. The advertised items may be categorized based on identifying means such as color, seasonal design, or the community of origin of the sale, product, packaging or other selected criteria. The catalog may be available or displayed at the retailer's location, posted on the retailer's website, sent directly to the consumer, or provided to consumers in any other suitable manner.

If the consumer has earned a discount from returning a bag or other packaging, the discount may be obtained by redeeming a coupon or other proof of return or the discount in any suitable manner. For example, the retailer may create a database that tracks the discount or discounts awarded to the individual. Thus, the consumer may track the global impact of purchasing recycled goods from the retailer. Alternatively or additionally, the consumer may possess a coupon or ticket redeemable for the discount. Still further, the consumer may possess a smart card which stores the consumer's accumulated benefits from returning bags, bottles or other packaging.

A portion of the proceeds for the sale of the recycled consumer goods may then be sent to the predetermined community. The catalog, the recycled products, or the bags or packaging themselves may prominently state that proceeds from the sale of recycled products go to a selected community of origin, thus encouraging the sale of these items to environmentally or socially conscious consumers.

The foregoing description of the invention illustrates and describes the present invention. Additionally, the disclosure shows and describes only the preferred embodiments of the invention, but it is to be understood that the invention is capable of use in various other combinations, modifications, and environments and is capable of changes or modifications within the scope of the inventive concept as expressed herein, commensurate with the above teachings, and/or the skill or knowledge in the art of recycling and, more particularly consumer recycling and incentive programs.

The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A method for recycling comprising:
receiving an item from a seller, the item comprising a consumable and packaging enclosing the consumable;
returning the packaging to the seller or seller's affiliate or agent after the consumable has been removed from the container; and
receiving a credit from the seller or seller's affiliate or agent in exchange for returning the container, the credit for application toward the purchase of an item made with previously returned packaging.

2. The method of claim 1, further comprising:
applying a portion of the proceeds of the purchase of the item made with previously returned packaging toward a predetermined community.

3. The method of claim 1, further comprising:
offering items made with previously returned packaging for purchase at retail, in one or more catalogs or via the Internet.

4. The method of claim 1, further comprising:
tracking a consumer's return of one or more items to the seller or seller's affiliate or agent.

5. The method of claim 1, further comprising:
tracking a consumer's purchase of items made with previously returned packaging.

6. The method of claim 1, wherein the packaging comprises bottles or other beverage containers.

7. The method of claim 1, wherein the packaging comprises a food container.

8. The method of claim 1, wherein the packaging comprises a condiment container.
